(19) United States
(12) Patent Application Publication
(10) Pub. No.: US 2005/0193610 A1
(43) Pub. Date: Sep. 8, 2005

(54) Circuit directory display device

(76) Inventor: Brian Emil Rost, Philadelphia, PA (US)

Correspondence Address: DUANE MORRIS, LLP;IP DEPARTMENT, ONE LIBERTY PLACE, PHILADELPHIA, PA, 19103-7396, US

(21) Appl. No.: 10/794,840

(22) Filed: Mar. 5, 2004

(51) Int. Cl. G09F 7/12

(52) U.S. Cl. 40/654.01; 40/594; 40/600

(57) ABSTRACT

A display (100) for recording updated information comprises a flexible, transparent front panel (102), and multiple, side-opening pockets (104) formed by at least one rear panel (106) against the front panel (102). An optional enlarged pocket (104x) has a corresponding opening (104cx). Placards or labels (110) for recording written information are inserted edgewise, first, into the gap (108) and then slid into openings (104c) of respective pockets (104). Thus the placards (110) have opposing edges that serve as stops against which the opposing placards (110) engage one another to resist their unintended removal from the pockets (104).

### BACKGROUND OF THE INVENTION

1. Field of the Invention

The present invention relates to informational directories and more particularly to a directory system for providing circuit information for electrical panels.

2. Description of the Prior Art

Directories for electrical panels such as circuit breaker panels are known for providing a user with information regarding electrical circuit layout and control, such as technical information regarding the capacity and size of the panel, and/or descriptive information regarding individual circuit breakers.

When an electrical contractor installs either a new electrical panel or modifies an existing one, the electrical contractor is required by the National Electric Code (NEC) to label or re-label the directory. If loads are removed or added to the electrical panel, for example more lights, outlet receptacles, computers, double wide circuit breakers, etc., the contractor must make the necessary changes to the directory.

Currently, modifications to the circuit director are either made by making handwritten entries in the provided directory, erasing, if possible, placing stickers on or near the circuit breakers, marking the enclosure with a permanent marker, or by making a custom panel sheet and taping the sheet to the panel cover. An electrical panel is subjected to actions that may cause the circuit directory to become lost, torn, or otherwise damaged. Panels are typically accessible by individuals, authorized and unauthorized, who may inadvertently misuse the directory.

Some directories are in the form of placards with numbers and an information entry line associated with each number. Each number represents a position on the panel where the associated circuit breaker is located. Typically, the information is printed or handwritten. The information entry slots or lines in these types of prior art directories are not interchangeable making modifications to individual entries more difficult. Previous information must be carefully erased or covered prior to entering the new information; or an entirely new placard must be prepared and substituted for the prior placard even if there is a change to only a single entry slot. The material of these placards is typically light gauge cardboard or heavy gauge paper which discolors and wears more easily over time, particularly when a placard is handled on a regular basis, such as, during routine maintenance operations.

The card-structured directories are either mounted by pressure sensitive adhesive directly to the panel cover, or held in a transparent plastic panel or metal channel, which is mounted to the panel cover. Those mounted by pressure sensitive adhesive have their own disadvantages depending where on the cover the panel is adhered. The pocket or channel mount makes the directory susceptible to being inadvertently lost or damaged. Since the panel covers are typically removed when servicing the electrical panel, all such panel mounted, card-structured directories pose problems of accessibility to the directory information. That is, when the cover has been removed and set aside in order to service the panel, the very information one needs to service the panel is now located elsewhere.

Another type of directory system employs self-adhesive, pressure sensitive, or magnetized individually marked labels which are placed next to individual circuit breakers. One of the disadvantages of this type of system is that modifications to the directory made near the panel and the circuit breakers increase the possibility of disturbing other circuits which could cause tripped circuits.

Yet another type of circuit directory for electric panels is described in U.S. Pat. No. 5,850,705. In this directory, hinged sleeves receive circuit placards which contains printed information and indicia specific to particular circuit breakers in the electrical panel. However, the sleeves overlap and cover one another in splayed fashion, which requires the sleeves on top of others to be flipped upside down, to view placards in sleeves that are covered by the top sleeves. In this type of directory, the pockets become easily worn and damaged, and the placards can be dislodged when the sleeves are flipped. Further, the pockets collect contaminants that fall into open tops of the pockets.

### SUMMARY OF THE INVENTION

A circuit directory display device for electrical panels comprises a flexible, transparent front panel having spaced apart upper and lower edges and spaced apart first and second side edges extending between the upper and lower edges thereof. A first rear panel having a width defined by spaced apart upper and lower edges, and a length defined by spaced apart first and second side edges extending between the upper and lower edges thereof is connected to the front panel with the first side edge of the rear panel fastened along the first side edge of the front panel and the spaced apart upper and lower edges of the first rear panel being connected along the respective spaced apart upper and lower edges of the front panel to form at least a first pocket. A second rear panel having a width defined by spaced apart upper and lower edges and a length defined by spaced apart first and second side edges extending between the upper and lower edges thereof is connected to the front panel with the second side edge of the rear panel fastened along the second side edge of the front panel and the spaced apart upper and lower edges of the first rear panel being connected along the respective spaced apart upper and lower edges of the front panel to form at least a second pocket. The widths of the first and second rear panels are dimensioned such that a gap is formed between the second side edge of the first rear panel and the first side edge of the second rear panel. A device, for releasably attaching the display device to a surface of said electrical panel is disposed on at least one of said rear panels.

### BRIEF DESCRIPTION OF THE DRAWINGS

FIG. 1 is a fragmentary front elevation view of a directory display device.

FIG. 2 is a fragmentary rear elevation view of a rear panel of the directory display device of FIG. 1.

FIG. 3 is a fragmentary rear elevation view of the directory display device depicted in FIG. 1.

Each of FIGS. 4 and 5 is a fragmentary rear elevation view of a further embodiment of a rear panel.

FIG. 6A is a section view taken along the line 6-6 of FIG. 1.

FIG. 6B is a view similar to FIG. 6A, and further disclosing bending of a directory display device.

FIG. 6C is a view similar to FIG. 6A, and further disclosing further bending of a directory display device.

### DETAILED DESCRIPTION

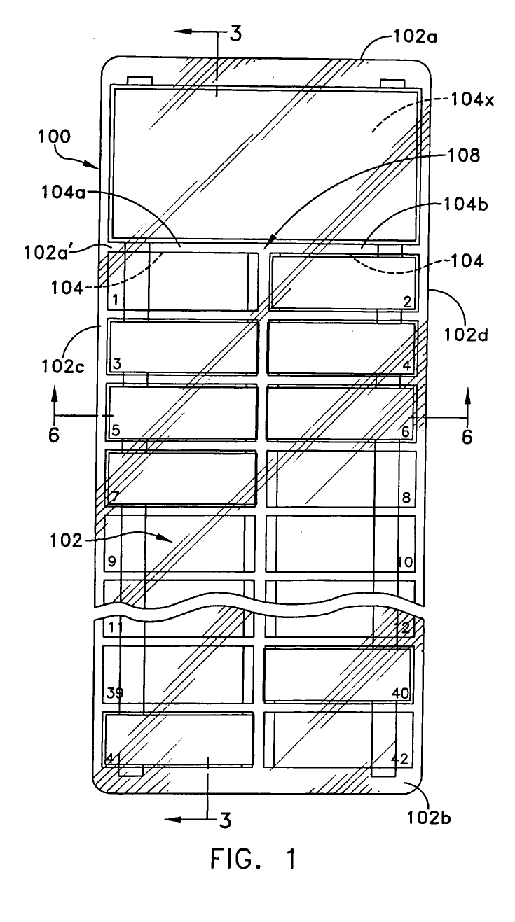

FIG. 1 discloses a device in the form of a display (100) for a directory, for example, a circuit directory. The display (100) is advantageously thin and flat for mounting on a panel with a minimum of intrusion, such as, on the inside of a door panel on an electrical panel box, or on a wall panel adjacent to an electrical panel box for electrical power circuits or a separate panel box for local area network communications circuits.

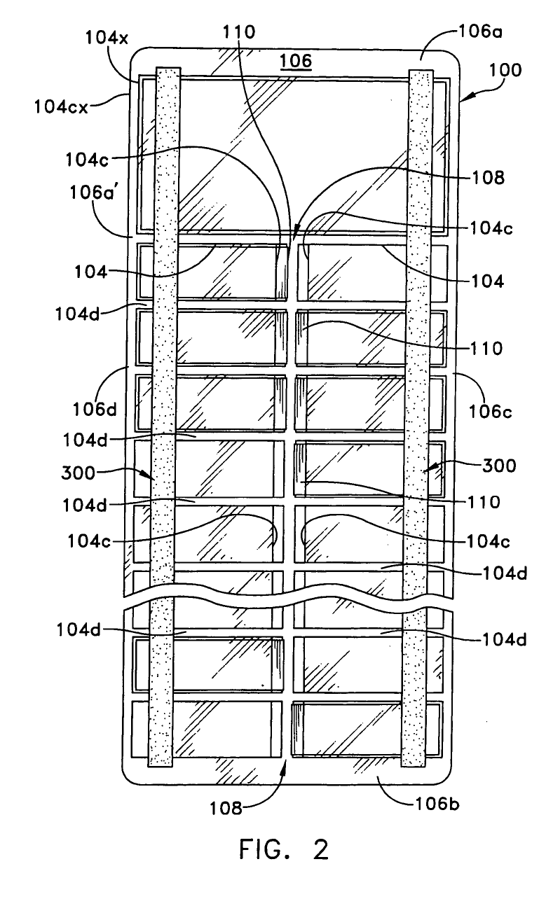

FIG. 1 further discloses that the display (100) comprises a flexible, transparent front panel (102), and FIG. 2 discloses multiple pockets (104) formed by at least one rear panel (106) against the front panel (102). The pockets (104) are arranged in at least one pair of vertical columns. A lengthwise gap (108) separates the pockets (104) of a first column (104a) from the pockets (104) in a second column (104b). As disclosed by FIG. 2, openings (104c) of the pockets (104) face the gap (108) to define the pockets (104) as side-opening pockets (104). An optional enlarged pocket (104x) has a corresponding side opening (104cx). The optional enlarged pocket (104x) is advantageously located at the ends of the columns (104a) and 104b), such that the optional enlarged pocket (104x) can be eliminated during manufacture, by cutting the panels (102) and (106) to desired lengths, from sheets of material, so as to end at the two columns (104a) and (104B). Further, the optional enlarged pocket (104x) is at a top end or bottom end of the display, merely by inverting the display, at one orientation or another.

The openings (104c) of the side-opening pockets (104) and (104x) are positioned along substantially vertical edges of the pockets (104) and (104x), to avoid catching any falling contaminates, and to further avoid accumulation of fallen contaminants in the pockets (104).

One important feature of the invention is that a surface of each placard or label (110) on which information is to be recorded, faces toward the front panel (102) for protection of the information recording surface before information is recorded. Thus the placard (110) can be preinstalled in a pocket (104) and stored therein until information is recorded. Any information that becomes later recorded on the surface then faces toward the front panel (102) for protection. The transparent front panel (102) covers and protects the information, and allows a person to read the information through the front panel without having to handle the placard (110). The front panel (102) is cut from a sheet of flexible, transparent or at least, substantially semi-transparent polymer, including, and not limited to; polyvinyls, polyethylenes, polyurethanes, polypropylenes, polycarbonates and combinations thereof. Further, the front panel (102) can be fabricated from a water resistant material or can be coated with a water resistant material.

As further disclosed by FIGS. 1 and 2, the opening (104c) of each pocket (104) in the first column (104a) is opposite at least one opening (104c) of a pocket (104) in the second column (104b). Conversely, the opening (104c) of each pocket (104) in the second column (104b) is opposite at least one opening (104c) of a pocket (104) in the first column (104a). Thus, the gap (108) is between the pockets (104) of at least one pair of pockets (104). Alternatively, the gap (108) is between the pockets (104) of more than one pair. Placards or labels (110) for recording written information for a directory are inserted edgewise, first, into the gap (108) and then slid into openings (104c) of respective pockets (104). The placards or labels (110) are semi-rigid, and are sized for insertion into said pockets (104), and adjacent edges of lateral pairs of inserted placards or labels (110) are positioned proximate each other at the gap (108).

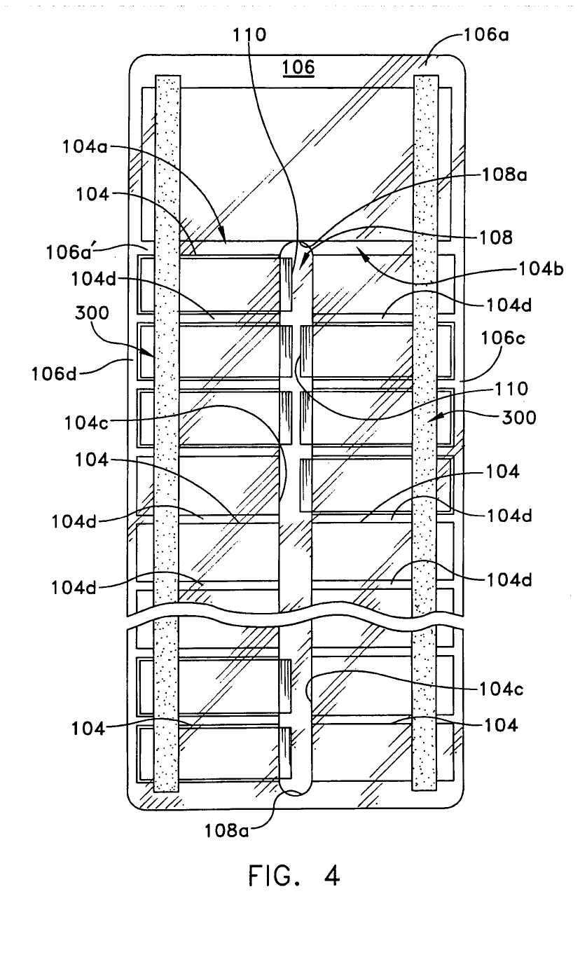

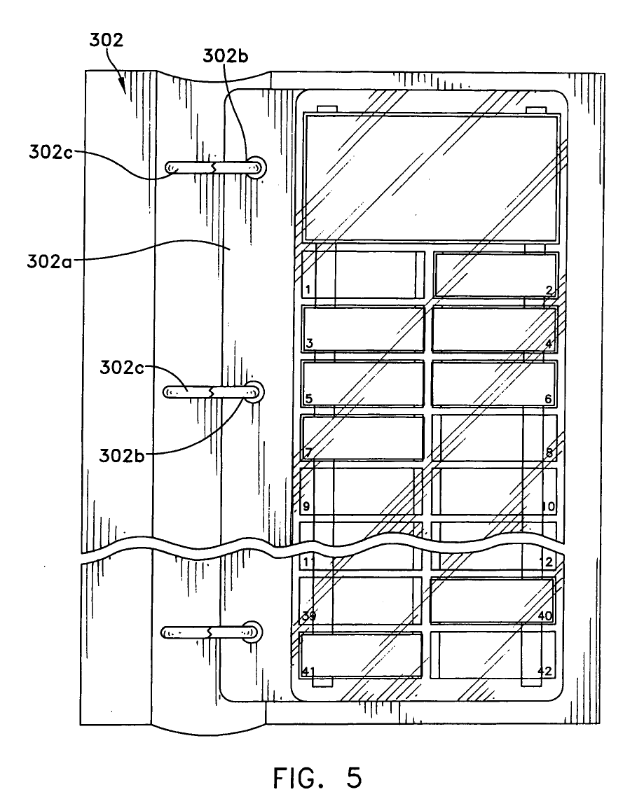

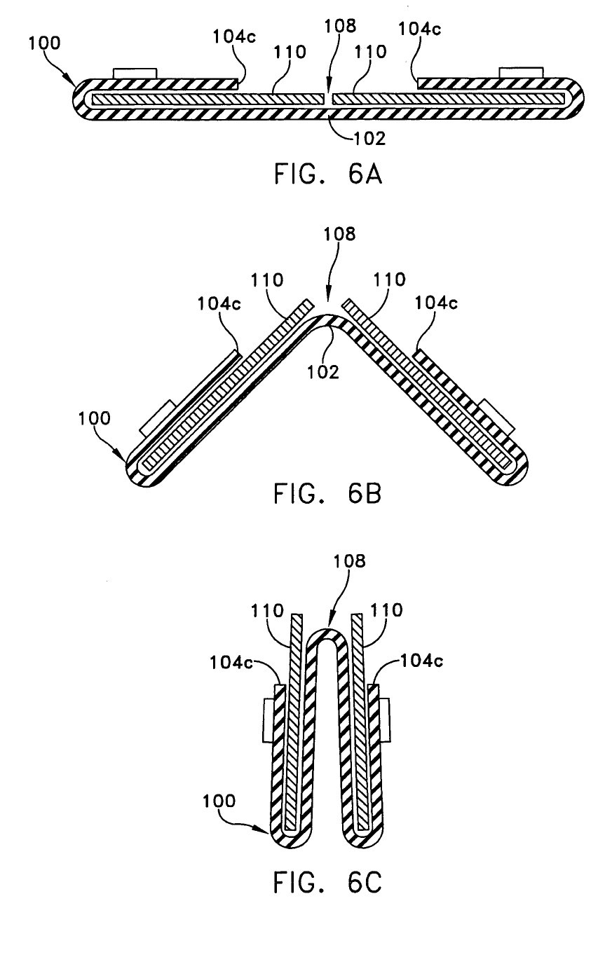

After at least two placards (110) are inserted in pockets (104), respectively, in the two columns (104a) and 104b), a placard (110) in a pocket (104) of the first column (104a) opposes at least one placard (110) in a pocket (104) of the second column (104c). Conversely, a placard (110) in a pocket (104) of the second column (104b) opposes at least one pocket (104) of the first column (104a). Thus the placards (110) have opposing edges in substantially the same plane. The opposing edges serve as stops against which the opposing placards (110) engage one another to resist their removal from respective pockets (104). Thus, the opposing placards (110) are protected against their unintended removal from the pockets (104), when the display (100) is substantially flat, according to FIG. 6A. Similarly, when an empty pocket (104) in a first column (104c) faces a placard (110) in a pocket (104) in a second column (104c), the edge of the empty pocket (104) faces the edge of the placard (110) to resist removal of the placard (110) from the pocket (104).

With reference to FIGS. 6A, 6B and 6C, to remove a placard (110), for example, for the purpose of updating the information to be recorded, the flexible display (100) is bent along the gap (108) to double the front panel (102) back on itself, which pivots the pockets (104) of one column (104a) back-to back with the pockets (104) of the opposed column (104b), and which exposes the openings (104c) of the pockets (104), and exposes the opposing edges of the placards (110). Then, the exposed edge of a selected placard 110) can be grasped to remove the placard (110) from its pocket (104).

When the directory is a circuit directory, each circuit is identified with information written on a corresponding placard (110). The placard (110) further has indicia identifying a circuit disconnect, such as, a circuit breaker in a panel box. The indicia corresponds to the number position of the circuit breaker in the panel box. Typically, a panel box has a number of circuit breakers that act as voltage overload and temperature overload disconnects. Further, an individual circuit breaker can be shut off by hand to shut off a circuit for servicing, without having to disconnect power from all circuits. Another panel box may be present, to have circuit breakers for disconnecting local area network communications circuits, for example, cable television, closed circuit video or audio, Ethernet local area networks, and remote control circuits for appliances and HVAC systems.

For the purposes of discussion, the rear panel (106) is shown in FIGS. 2 and 4 as being transparent. The rear panel (106) is cut from one or more than one flexible sheet of material, including, and not limited to; polyvinyls, polyethylenes, polyurethanes, polypropylenes, polycarbonates and combinations thereof. Further, the front panel (102) can be fabricated from a water resistant material or can be coated with a water resistant material. It can be transparent, semi transparent or even opaque, since the information recorded on the placards (110) face toward the front panel (102). According to embodiments of the invention, the rear panel (106) can be of one piece construction, or, alternately, of multiple piece construction. First, embodiments of a one piece construction will now be described.

FIG. 2 discloses the rear panel (106) as a single sheet having the pocket openings (104c) as individual cuts through the single sheet. FIG. 4 discloses the rear panel (106) as a single sheet having the pocket openings (104c) defined by an elongated, slotted opening (108a) through the thickness of the rear panel (106). Further, for example, the opening (108a) defines the gap (108), and is positioned substantially at the center of said rear panel (106) and between said lower and upper edges (106a) and (106b) thereof. The pockets (104) for receiving placards or labels (110) are formed between said front and rear panels (102) and (106) on each side of said gap (108).

With further reference to FIG. 1, the flexible, transparent front panel (102) has a spaced apart upper edge (102a) and lower edge (102b), and a spaced apart first side edge (102c) and second side edge (102d) extending between said upper and lower edges (102a) and (102b).

The rear panel (106) has a spaced apart upper edge (106a) and lower edge (106b), and spaced apart first side edge (106c) and second side edge (106d) extending between said upper and lower edges (106a) and (106b) connected to said front panel (102) along a narrow line or seam with the respective upper edge (102a), lower edge (102b), first side edge (102c) and second side edge (102d). Each narrow line or seam joining the panels (102) and (106) includes, and is not limited to; a heat seal, a fused junction, a sewn seam, an adhesive joint, a caulked joint, a tape, a fastener closed joint and combinations thereof. A narrow line or seam (106a′) extends parallel to the upper and lower edges (106a) and (106b) at the ends of the two columns (104a) and (104b), which, not only sizes the enlarged pocket (104x), but also serves as a seam at an optional upper edge of the display (100) so as to eliminate the optional enlarged pocket (104x) when the rear panel (106) and the front panel (102) are cut to desired lengths from respective sheets of material.

According to a further embodiment of the invention, the rear panel (106) is connected to the front panel (102) along a first lateral line or seam (106a′) extending between said first and second side edges (106c) and (106d) intermediate of and substantially parallel to said upper edge (106a) and lower edge (106b), whereby a pocket (104x) for receiving an information label (110) is formed between said front panel (102) and the rear panel (106). The pocket (104x) is either, an upper pocket (104x), or a lower pocket (104x) with the display (104) inverted in orientation.

With reference to each of FIGS. 2 and 4, each pocket (104) is defined, as being outlined at its periphery, by a respective thin line or seam (104d) joining the rear panel (106) and front panel (102). According to an embodiment of the invention, the rear panel (106) is connected to the front panel (102) along at least one narrow line or seam (104d) extending between said first side edge (106c) and second side edge (106d) intermediate to, and substantially parallel to, said upper edge (106a) and lower edge (106b), whereby at least one pocket (104) for receiving a label (110) is formed between said front panel (102) and rear panel (106) on each side of said gap (108).

Similarly, said front panel (102) and rear panel (106) are connected along a plurality of spaced lines or seams (104d) extending between said first edge (106c) and second side edge (106d) intermediate to and substantially parallel to said upper edge (106a) and lower edge (106b), whereby multiple pockets (104) for receiving labels (110) are formed between said front panel (102) and rear panel (106) on each side of said gap (108).

According to a further embodiment of the invention, said plurality of lines or seams (104d) are substantially equally spaced, whereby multiple pockets (104) of substantially equal size are formed.

According to another embodiment of the present invention, with reference to FIG. 4, the rear panel (106) is made by two panel pieces of sheet material for the panel (106). The two panel pieces comprise, a sheet of material for column (104a) of the rear panel (106) and a sheet of material for column (104b) of the rear panel (106). Thus, two panel pieces (104a) and (104b) are assembled with the front panel (102), so as to extend against the front panel (102). The two panel pieces (104a) and (104b) are separated by the gap (108). The two panel pieces (104a) and (104b) have respective side edges (106d) and (106c) connected along thin lines or seams to the front panel (102) at the edges (102c) and (102d) of the front panel (102). Further, a bottom edge (106b) of each of the two panel pieces (104a) and (104b) are connected to the bottom edge (102b) of the front panel (102) along a thin line or seam thereat. When the enlarged pocket (104x) is not present, then each of the two panel pieces (104a) and (104b) are cut to fit along a top edge (106a′) that extends along the thin line or seam (106a′) of the rear panel (106). A thin line or seam extends along each top edge (106a′) of the panel pieces (104a) and (104b) to join the rear panel (106) with the front panel (102) along the thin line or seam (102a′) of the front panel (102).

According to a further embodiment of the invention, the two panel pieces (104a) and (104b) are combined with the front panel (102) into a single sheet of material, that is folded upon itself, so as to fold the sheet of material to extend the two panel pieces (104a) and (104b) behind the front panel (102), and against the front panel (102). According to one embodiment, the two panel pieces (104a) and (104b) are separated by the gap (108). According to another embodiment, the two panel pieces (104a) and (104b) extend to overlap and cover the gap (108) with a flap that can be bent back on itself to expose the gap (108) under the flap. The two panel pieces (104a) and (104b) have respective side edges (106d) and (106c) that comprise folded thin lines or seams at the folded edges (102c) and (102d) of the front panel (102). Further, a bottom edge (106b) of each of the two panel pieces (104a) and (104b) are connected to the bottom edge (102b) of the front panel (102) along a thin line or seam thereat. When the enlarged pocket (104x) is not present, then each of the two panel pieces (104a) and (104b) are cut to fit along a top edge (106a′) that extends along the thin line or seam (106a′) of the rear panel (106). A thin line or seam extends along each top edge (106a′) of the panel pieces (104a) and (104b) to join the rear panel (106) with the front panel (102) along the thin line or seam (102a′) of the front panel (102).

When the enlarged pocket (104x) is present on the display (100), it may be integral with either of the two panel pieces (104a) or (104b). Alternatively, the enlarged pocket (104x) is made as a third panel piece of sheet material for the rear panel (106). Further, the third panel piece for the enlarged pocket (104x) is connected by a thin line or seam along the top edge (106a) to connect the same with a corresponding top edge (102a) of the front panel (102). The enlarged pocket (104x) is outlined further by the thin line or seam (106a′) that extends across each of the two panel pieces (104a) and (104b).

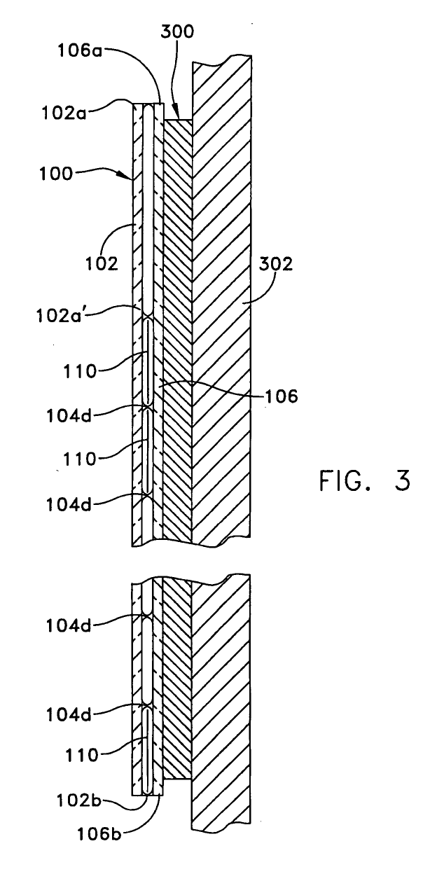

According to a further embodiment of the invention, with reference to FIG. 3, the display (100) includes means (300) for releasably attaching said display (100) to a use object (302) disclosed by FIG. 3. According to an embodiment of the invention, said use object (302) includes, and is not limited to; an electrical panel, a door on an electrical panel or a wall panel. Said means (300) comprises at least a first magnetic material disposed on said rear panel (106) for releasable attachment of the display (100) to a ferrous use object (302). The terminology “magnetic material” includes and is not limited to, one or more of, a magnetized flexible or stiff polyvinyl material, a magnetized strip, a die-cut magnet, a magnetized sheet or a magnetized dot. For example, the magnetic material is attached with adhesive on the rear panel (106). Further, for example, the magnetic material is inside one or more of the pockets (104) and (104x), wherein the magnetic field of the magnetic material extends through the thin rear panel (106) for releasable attachment of the display (100) to a ferrous use object (302). According to a further embodiment of the invention, disclosed by FIGS. 2 and 4, said means (300) comprises a first magnetic material (300) disposed on said rear panel (106) along said first side edge (106d) thereof and another magnetic material (300) disposed along said second side edge (106c) thereof.

According to a further embodiment of the invention, said means (300) comprises a strip of hook fastener material (300), for example, at least a first VELCRO® material fastener device (300) disposed on said rear panel (106).

According to a further embodiment of the invention, said means (300) comprises a first strip of hook fastener material (300), for example, a first VELCRO® material fastener device (300) disposed on said rear panel (106) along said first side edge (106d) thereof and a second VELCRO® material fastener device (300) disposed on said rear panel (106) along said second side edge (106c) thereof.

According to a further embodiment of the invention, disclosed by FIG. 5, said use object is a ring binder (302) and said means (300) comprises a tab (300a) extending from one of said side edges (102c), said tab (300a) having at least one hole (302b) therein for engaging a ring (302c) in said binder (300).

Although preferred embodiments are described, other embodiments and modifications of the invention are intended to be covered by the spirit and scope of the appended claims.

1. A directory, comprising:
a. a flexible, transparent front panel;
b. a rear panel connected to said front panel;
c. side opening pockets facing one another to receive respective labels therein and to resist removal of each of said labels.

2. A display in accordance with claim 1 wherein said front and rear panels are connected along a plurality of substantially equally spaced lines, whereby multiple pockets for receiving labels are formed between said front and rear panels on each side of a gap.

3. A display in accordance with claim 1 wherein said front and rear panels are joined together to form said pockets.

4. A display in accordance with claim 3 wherein said front and rear panels are connected along a plurality of substantially equally spaced lines, whereby multiple pockets for receiving labels are formed between said front and rear panels on each side of a gap.

5. A display in accordance with claim 3 and further comprising:
means for releasably attaching said display device to an electrical panel.

6. A display in accordance with claim 5 wherein said means for releasably attaching said display device to said electrical panel comprises a first magnetic material disposed on said rear panel along said first side edge thereof and a second magnetic material disposed on said rear panel along said second side edge thereof.

7. A display in accordance with claim 5 wherein said means comprises at least a first VELCRO® fastener device disposed on said rear panel.

8. A display in accordance with claim 5 wherein said means comprises a first strip of VELCRO® material disposed on said rear panel along said first side edge thereof and a second strip of VELCRO® material disposed on said rear panel along said second side edge thereof.

9. A display in accordance with claim 4 and further comprising: semi-rigid labels, sized for insertion into said pockets such that the adjacent edges of lateral pairs of inserted labels are positioned proximate each other.

10. A display in accordance with claim 4 wherein said means comprises a tab extending from one of said side edges, said tab having at least one hole therein for engaging a ring in a ring binder.

11. A display comprising:
a. a flexible, transparent front panel having spaced apart upper and lower edges and spaced apart first and second side edges extending between said upper and lower edges;
b. a rear panel having spaced apart upper and lower edges and spaced apart first and second side edges extending between said upper and lower edges connected to said front panel along respective upper, lower, one of said first or second side edges, along a first lateral line extending between said first and second side edges intermediate and substantially parallel to said upper and lower edges, and along the other of said first or second side edges from said lower edges to said first lateral line whereby a pocket for receiving an information label is formed between said front and rear panels between said first lateral line and said upper edges thereof;
c. a gap in substantially the center of said rear panel extending between said lower edge thereof and said first lateral line whereby a pocket for receiving a directory label is formed between said front and rear panels on each side of said gap; and
d. means for releasably attaching said display device to a use object.

12. A display in accordance with claim 11 wherein said front and rear panels are connected along at least one additional lateral line extending between said first and second side edges intermediate and substantially parallel to said first lateral line and said lower edges, whereby pockets for receiving directory labels are formed between said front and rear panels on each side of said gap.

13. A display in accordance with claim 12 wherein said front and rear panels are connected along a plurality of substantially equally spaced lines extending between said first and second side edges intermediate and substantially parallel to said first lateral line and said lower edges, whereby multiple pockets for receiving directory labels are formed between said front and rear panels on each side of said gap.

14. A display in accordance with claim 13 wherein said plurality of lines extending between said first and second side edges are substantially equally spaced, whereby multiple pockets for receiving directory labels of substantially equal size are formed between said front and rear panels on each side of said gap.

15. A display in accordance with claim 14 wherein said use object is an electrical panel and said releasably attaching means comprises at least a first magnetic material disposed on said rear panel.

16. A display in accordance with claim 15 wherein said releasably attaching means comprises a first magnetic material disposed on said rear panel along said first side edge thereof and a second magnetic material disposed on said rear panel along said second side edge thereof.

17. A display in accordance with claim 14 wherein said use object is an electrical panel and said releasably attaching means comprises at least a first VELCRO® fastening device disposed on said first rear panel.

18. A display in accordance with claim 17 wherein said releasably attaching means comprises a first strip of VELCRO® material disposed on said rear panel along said first side edge thereof and a second strip of VELCRO® material disposed on said rear panel along said second side edge thereof.

19. A display in accordance with claim 14 additionally comprises semi-rigid directory labels, sized for insertion into said pockets such that the adjacent edges of lateral pairs of inserted directory labels are positioned proximate each other.

20. A display comprising:
a. a flexible, transparent front panel having spaced apart upper and lower edges and spaced apart first and second side edges extending between said upper and lower edges;
b. a rear panel having spaced apart upper and lower edges and spaced apart first and second side edges extending between said upper and lower edges connected to said front panel along respective upper, lower, one of said first or second side edges, along a first lateral line extending between said first and second side edges intermediate and substantially parallel to said upper and lower edges, and along the other of said first or second side edges from said lower edges to said first lateral line whereby a pocket for receiving an information label is formed between said front and rear panels between said first lateral line and said upper edges thereof;
c. a pair of apertures in said rear panel on either side of, and substantially adjacent to, the approximate center of said rear panel between said lower edge thereof and said first lateral line, whereby each aperture defines an opening in a pocket formed between said front and rear panels on each side of said center for receiving a directory label; and
d. means for releasably attaching said display device to a use object.

21. A display in accordance with claim 20 wherein said front and rear panels are connected along at least one additional lateral line extending between said first and second side edges intermediate and substantially parallel to said first lateral line and said lower edges, whereby pockets for receiving directory labels are formed between said front and rear panels on each side of said approximate center, and pairs of apertures are disposed in said rear panel on either side of, and substantially adjacent to, said approximate center, whereby each aperture defines an opening in a respective pocket for receiving a directory label.

22. A display in accordance with claim 21 wherein said front and rear panels are connected along a plurality of substantially equally spaced lines extending between said first and second side edges intermediate and substantially parallel to said first lateral line and said lower edges, whereby multiple pockets for receiving directory labels are formed between said front and rear panels on each side of said approximate, and a plurality of pairs of apertures are disposed in said rear panel on either side of, and substantially adjacent to, said approximate center, whereby each aperture defines an opening in a respective pocket for receiving a directory label.

23. A display in accordance with claim 22 wherein said plurality of lines extending between said first and second side edges are substantially equally spaced, whereby multiple pockets for receiving directory labels of substantially equal size are formed between said front and rear panels on each side of said approximate center.

24. A display in accordance with claim 23 wherein said use object is an electrical panel and said releasably attaching means comprises at least a first magnetic material disposed on said rear panel.

25. A display in accordance with claim 24 wherein said releasably attaching means comprises a first magnetic material disposed on said rear panel along said first side edge thereof and a second magnetic material disposed on said rear panel along said second side edge thereof.

26. A display in accordance with claim 23 wherein said use object is an electrical panel and said releasably attaching means comprises at least a first VELCRO® fastening device disposed on said first rear panel.

27. A display in accordance with claim 26 wherein said releasably attaching means comprises a first strip of VELCRO® material disposed on said rear panel along said first side edge thereof and a second strip of VELCRO® material disposed on said rear panel along said second side edge thereof.

28. A display in accordance with claim 23 additionally comprises semi-rigid directory labels, sized for insertion into said pockets such that the adjacent edges of lateral pairs of inserted directory labels are positioned proximate each other.

29. A circuit directory display device for electrical panels comprising:
a. a flexible, transparent front panel having spaced apart upper and lower edges and spaced apart first and second side edges extending between said upper and lower edges;
b. a first rear panel having spaced apart upper and lower edges and spaced apart first and second side edges extending between the upper and lower edges of said first rear panel, said first side edge of said first rear panel being connected along said first side edge of said front panel and said spaced apart upper and lower edges of said first rear panel being connected along said respective spaced apart upper and lower edges of said front panel to form at least a first pocket therebetween;
c. a second rear panel having spaced apart upper and lower edges and spaced apart first and second side edges extending between the upper and lower edges of said second rear panel, said second side edge of said second rear panel being connected along said second side edge of said front panel and said spaced apart upper and lower edges of said second rear panel being connected along said respective spaced apart upper and lower edges of said front panel to form at least a second pocket therebetween, said first edge of said second rear panel being spaced from said second side edge of said first rear panel to form a gap therebetween; and
d. means, disposed on at least one of said rear panels, for releasably attaching said display device to a surface of said electrical panel.

30. The device in accordance with claim 29 wherein:
a. said first rear panel is connected to said front panel along at least one line extending from said first side edge of said first rear panel to said second side edge of said first rear panel intermediate said upper and lower edges of said first rear panel to form at least two pockets between said front panel and said first rear panel; and
b. said second rear panel is connected to said front panel along at least one line extending from said first side edge of said second rear panel to said second side edge of said second rear panel intermediate said upper and lower edges of said second rear panel to form at least two pockets between said front panel and said second rear panel.

31. The device in accordance with claim 30 wherein said means for releasably attaching said display device comprises a first magnetic material disposed on said first rear panel along said first side edge thereof and another magnetic material disposed on said second rear panel along said second side edge thereof.

32. The device in accordance with claim 30 wherein said means for releasably attaching said display device comprises a first strip of VELCRO® material disposed on said first rear panel along said first side edge thereof and a second strip of VELCRO® material disposed on said second rear panel along said second side edge thereof.

33. A circuit directory display device for electrical panels comprising:
a. a flexible, transparent front panel having spaced apart upper and lower edges and spaced apart first and second side edges extending between said upper and lower edges;
b. a rear panel having spaced apart upper and lower edges and spaced apart first and second side edges extending between said upper and lower edges connected to said front panel along respective upper, lower, first side and second side edges and along a first line extending between said first and second side edges intermediate and substantially parallel to said upper and lower edges; and
c. a gap formed in said rear panel extending between said lower edge thereof and said first line intermediate and substantially parallel to said side edges thereof.

34. The device in accordance with claim 33 wherein said rear panel is connected to said front panel on either side of said gap along at least a second line extending between said first and second side edges intermediate and substantially parallel to said first line and said lower edges.
